(19) United States
(12) Patent Application Publication
(10) Pub. No.: US 2019/0201980 A1
(43) Pub. Date: Jul. 4, 2019

(54) Systems And Methods For Additive Manufacturing Using Highly Reactive Materials

(71) Applicant: DMG Mori USA, Hoffman Estates, IL (US)

(72) Inventors: Gregory A. Hyatt, South Barrington, IL (US); Karl Hranka, Hoffman Estates, IL (US)

(73) Assignee: DMG Mori USA, Hoffman Estates, IL (US)

(21) Appl. No.: 16/302,491

(22) PCT Filed: May 16, 2017
(86) PCT No.: PCT/US17/32908

§ 371 Date: Nov. 16, 2018

Related U.S. Application Data
(60) Provisional application No. 62/337,092, filed on May 16, 2016.

(51) Int. Cl. B22F 3/105; B29C 64/393; B29C 64/106; B29C 64/371; B22F 1/00

(52) U.S. Cl. CPC B22F 3/1055; B29C 64/393; B33Y 50/02; B29C 64/371; B22F 1/0011; B29C 64/106

(57) ABSTRACT

A system for manufacturing a build object includes an additive manufacturing tool configured to utilize a powdered reactive material to construct the build object. The powdered reactive material includes a plurality of powder beads, wherein each powder bead has a bead diameter that is substantially similar to an ideal bead diameter. The system further includes apparatus configured to selectively shield the build object during additive manufacturing of the build object, by the additive manufacturing tool, using an inert gas. The ideal bead diameter is configured to be a bead diameter at which ignition of the powdered reactive material is inhibited, upon oxidation of the powdered reactive material.

### BACKGROUND

### Technical Field

The present disclosure generally relates to additive manufacturing systems and methods and, more particularly, relates to systems and methods for additive manufacturing using reactive materials.

### Description of the Related Art

Additive manufacturing techniques are often utilized to build a nearly limitless number of objects using a variety of materials. In some example techniques, an additive manufacturing machine of directed energy deposition (DED) type, also known as a blown powder type or powder spray type, is used for the deposition of metals. Such DED type machines are often implemented as part of, for example, hybrid manufacturing machines or processes that utilize both additive and subtractive manufacturing to create an object.

Some DED type processes and/or machines are used for deposition of reactive metals (e.g., Titanium), which can be more combustible than other, less reactive metals. Reactive metals can absorb excessive oxygen if oxygen is present while the metal is melted or is at an elevated temperature. As such, it is desirable to limit the oxygen presence around the build during deposition for both safety and build-quality concerns.

In prior additive manufacturing processes and machines, attempts have been made to limit the oxygen near the build of the additively manufactured object. For example, some machines have attempted to use gas purging methods to remove oxygen from the build site. Other machines have attempted to create a vacuum or near vacuum around the build to limit oxygen exposure to the reactive metals.

However, especially in the case of hybrid machining, often times the prior methods are not suitable, as environmental access around the build are necessary for certain functions of the machine. For example, in a hybrid manufacturing machine, milling operations can include frequent tool changes, which may open a build chamber or environment, exposing it to oxygen, among other gases, from an external environment. Therefore, new systems, methods, and machines for additive manufacturing with reactive metals, which address environmental exposure concerns for both safety and build quality purposes, are desired.

### SUMMARY

In accordance with one aspect of the disclosure, a system for manufacturing a build object is disclosed. The system includes an additive manufacturing tool configured to utilize a powdered reactive material to construct the build object. The powdered reactive material includes a plurality of powder beads, wherein each powder bead has a bead diameter that is substantially similar to an ideal bead diameter. The system further includes one or more nozzles configured to selectively shield the build object during additive manufacturing of the build object, by the additive manufacturing tool, using an inert gas. The system further includes at least one controller configured to control a toolpath of the additive manufacturing tool and to control positioning of the one or more nozzles relative to one or both of the build object and the additive manufacturing tool.

In accordance with another aspect of the present disclosure, a manufacturing machine, configured to build and machine a build object, is disclosed. The manufacturing machine includes an additive manufacturing tool configured to utilize a powdered reactive material to construct the build object. The powdered reactive material includes a plurality of powder beads, wherein each powder bead has a bead diameter that is substantially similar to an ideal bead diameter. The manufacturing machine further includes a flexible build support enclosure configured to, at least partially, house the build object during construction by the additive manufacturing tool and enclose, at least partially, inert gas for shielding the build object from environmental gases.

In accordance with yet another aspect of the disclosure, a method for manufacturing a build object is disclosed. The method includes selecting a reactive material to be used in constructing the build object. The method further includes determining an ideal bead diameter for the reactive material, the ideal bead diameter being a bead diameter at which ignition of the reactive material is inhibited, upon oxidation of the powdered material. The method further includes forming a powdered reactive material from the reactive material, the powdered reactive material including a plurality of powdered beads, each powder bead diameter being substantially similar to the ideal bead diameter. The method further includes feeding the powdered material to an additive manufacturing tool and constructing the build object by depositing the powdered material.

In accordance with another aspect of the present disclosure, which may be combined with one or more of the other aspects identified herein, the system for manufacturing a build object may further include at least one subtractive manufacturing tool and the at least one controller may be further configured to machining of the build object performed by the at least one subtractive manufacturing tool.

In accordance with another aspect of the present disclosure, which may be combined with one or more of the other aspects identified herein, the controller may be configured to control positioning of the one or more nozzles based on the location of a hot tail portion of the build object,

In accordance with another aspect of the present disclosure, which may be combined with one or more of the other aspects identified herein, the system for manufacturing a build object may further include a sensor configured to determine existence and location of the hot tail portion of the build object and the controller may be configured to control positioning of the one or more nozzles based, at least in part, on the existence and location of the hot tail portion, such that the hot tail portion is shielded by the inert gas during additive manufacturing

In accordance with another aspect of the present disclosure, which may be combined with one or more of the other aspects identified herein, the controller may be configured to control positioning of the one or more nozzles based, at least in part, on the toolpath of the additive manufacturing tool such that the build object is shielded by the inert gas during additive manufacturing.

In accordance with another aspect of the present disclosure, which may be combined with one or more of the other aspects identified herein, the system for manufacturing a build object may further include a powder feed configured to provide the powdered reactive material to the additive manufacturing tool and the ideal bead diameter may be greater than 100 microns,

In accordance with another aspect of the present disclosure, which may be combined with one or more of the other aspects identified herein, the powdered reactive material may be a Ti 6A14V and the ideal bead diameter is within a range of 106 microns to 180 microns.

In accordance with another aspect of the present disclosure, which may be combined with one or more of the other aspects identified herein, the flexible build support enclosure may include, at least, a bag that partially houses the build object during construction and encloses, at least, partially, the inert gas.

In accordance with another aspect of the present disclosure, which may be combined with one or more of the other aspects identified herein, the manufacturing machine configured to build and machine a build object may further include a rotatable member and the bag may be configured to not rotate with the rotatable member.

In accordance with another aspect of the present disclosure, which may be combined with one or more of the other aspects identified herein, the rotatable member may be a rotatable chuck configured to rotate independently from the bag and the bag may be affixed circumferentially around the chuck and configured to not rotate with the chuck.

In accordance with another aspect of the present disclosure, which may be combined with one or more of the other aspects identified herein, the manufacturing machine configured to build and machine a build object may further include a powder feed configured to provide the powdered reactive material to the additive manufacturing tool and the ideal bead diameter may be greater than 100 microns.

In accordance with another aspect of the present disclosure, which may be combined with one or more of the other aspects identified herein, the powdered reactive material may be Ti 6A14V and the ideal bead diameter may be within a range of 106 microns to 180 microns.

In accordance with another aspect of the present disclosure, which may be combined with one or more of the other aspects identified herein, determining the ideal bead diameter for the reactive material may include determining a bead diameter that is greater than 100 microns as the ideal bead diameter.

In accordance with another aspect of the present disclosure, which may be combined with one or more of the other aspects identified herein, determining the ideal bead diameter for the reactive material may include determining a bead diameter that is in the range of 106-180 microns as the ideal bead diameter.

In accordance with another aspect of the present disclosure, which may be combined with one or more of the other aspects identified herein, selecting the reactive material to be used in constructing the build object may include selecting a Titanium alloy as the reactive material.

In accordance with another aspect of the present disclosure, which may be combined with one or more of the other aspects identified herein, selecting the reactive material to be used in constructing the build object may include selecting Ti 6AV14V as the reactive material.

In accordance with another aspect of the present disclosure, which may be combined with one or more of the other aspects identified herein, method for manufacturing a build object may further include selectively shielding the build object during construction of the build object by using an inert gas.

In accordance with another aspect of the present disclosure, which may be combined with one or more of the other aspects identified herein, method for manufacturing a build object may further include machining the build object, using one or more subtractive manufacturing tools.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a front elevation of a computer numerically controlled machine in accordance with one embodiment of the present disclosure, shown with safety doors closed.

FIG. 2 is a front elevation of a computer numerically controlled machine illustrated in FIG. 1, shown with the safety doors open.

FIG. 3 is a perspective view of certain interior components of the computer numerically controlled machine illustrated in FIGS. 1 and 2, depicting a machining spindle, a first chuck, a second chuck, and a turret.

FIG. 4 a perspective view, enlarged with respect to FIG. 3 illustrating the machining spindle and the horizontally and vertically disposed rails via which the spindle may be translated.

FIG. 5 is a side view of the first chuck, machining spindle, and turret of the machining center illustrated in FIG. 1.

FIG. 6 is a view similar to FIG. 5 but in which a machining spindle has been translated in the Y-axis.

FIG. 7 is a front view of the spindle, first chuck, and second chuck of the computer numerically controlled machine illustrated in FIG. 1, including a line depicting the permitted path of rotational movement of this spindle.

FIG. 8 is a perspective view of the second chuck illustrated in FIG. 3, enlarged with respect to FIG. 3.

FIG. 9 is a perspective view of the first chuck and turret illustrated in FIG. 2, depicting movement of the turret and turret stock in the Z-axis relative to the position of the turret in FIG. 2.

FIG. 10 is a front view of the computer numerically controlled machine of FIG. 1 with the front doors open.

FIG. 11 is a perspective view of an exemplary tool changer of the machine of FIG. 1.

FIGS. 12(a) to 12(d) are perspective views showing operation of the tool changer of FIG. 11.

FIG. 13 is a schematic illustration of a material deposition assembly for use with the computer numerically controlled machine of FIG. 1.

FIG. 14 is a side elevation view of a material deposition assembly having a removable deposition head.

FIG. 15 is a side elevation view of an alternative embodiment of a material deposition assembly having a removable deposition head.

FIG. 16 is a side elevation view, in partial cross-section, of a lower processing head used in the material deposition assembly of FIG. 14.

FIG. 17 is a perspective view of a first gas delivery nozzle, for use with or in conjunction with the machine of FIG. 1 and/or the material deposition heads of FIGS. 14-16.

FIG. 18 is a perspective view of a second gas delivery nozzle, for use with or in conjunction with the machine of FIG. 1 and/or the material deposition heads of FIGS. 14-16.

FIG. 19 is a side elevation view of a portion of a material deposition head, depositing materials on a substrate and utilizing multiple gas delivery nozzles during deposition.

FIG. 20 is a microscopically magnified view of a feed powder for use with the machine(s) of the instant application.

FIG. 21 is a perspective view of example gas delivery nozzles for use with an additive manufacturing machine.

FIG. 22 is a front view of the spindle, first chuck, and second chuck of the computer numerically controlled machine illustrated in FIG. 1, including an additive manufacturing tool and a bag for housing a build within an inert gaseous environment during additive manufacturing by the additive manufacturing tool.

FIG. 23 is a perspective view of a bag for housing a build on a substrate within an inert gaseous environment, during additive manufacturing by an additive manufacturing tool.

FIG. 24 is a flowchart representative of a method for manufacturing a part using a hybrid machine, in accordance with another embodiment of the disclosure.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

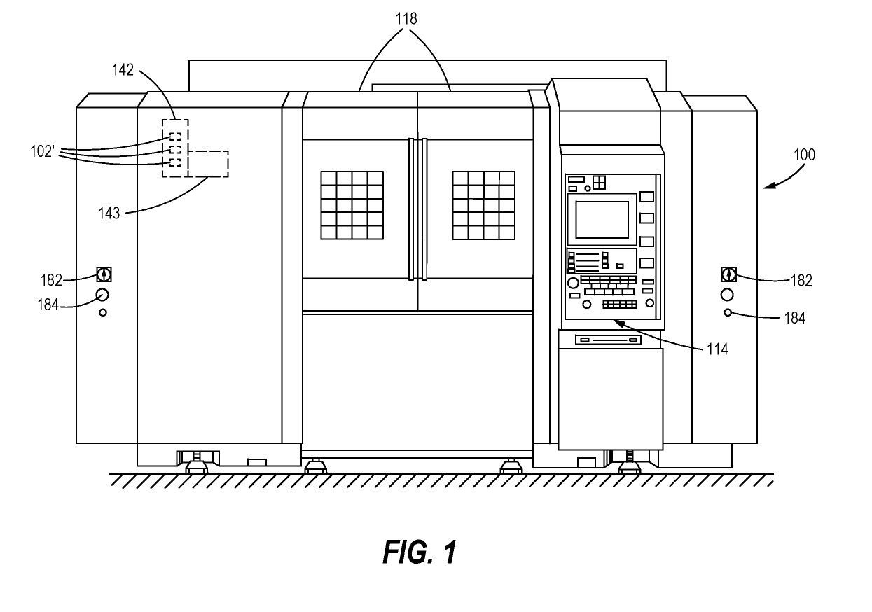

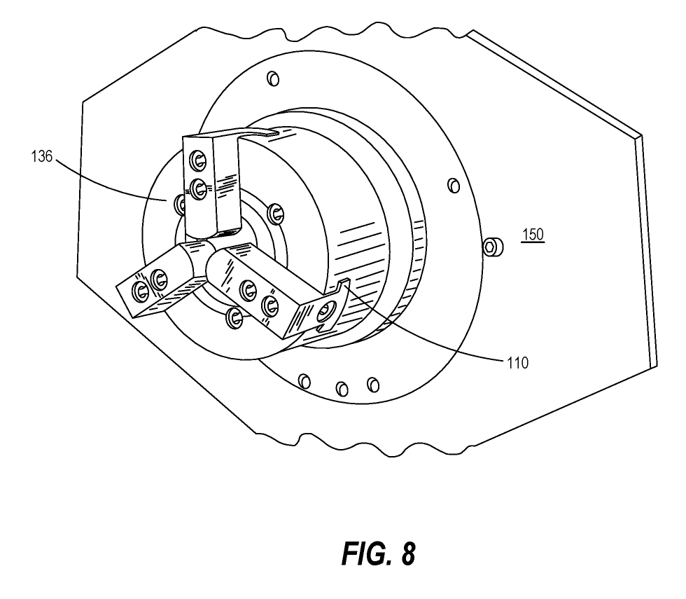

Any suitable apparatus may be employed in conjunction with the methods disclosed herein. In some embodiments, the methods are performed using a computer numerically controlled machine, illustrated generally in FIGS. 1-10. A computer numerically controlled machine is itself provided in other embodiments. The machine 100 illustrated in FIGS. 1-10 is an NT-series or LT-series machine, versions of which are available from DMG/Mori Seiki USA, the assignee of the present application. Alternatively, DMG/Mori Seiki's DMU-65 (a five-axis, vertical machine tool) machine tool, or other machine tools having different orientations or numbers of axes, may be used in conjunction with the apparatus and methods disclosed herein. While systems and methods disclosed herein, directed towards methods for additive manufacturing, may be performed using such machines, the contents herein are not limited to being performed on such machines.

In general, with reference to the NT-series machine illustrated in FIGS. 1-3, one suitable computer numerically controlled machine 100 has at least a first retainer and a second retainer, each of which may be a tool retainer (such as a spindle retainer associated with spindle 144 or a turret retainer associated with a turret 108) or a workpiece retainer (such as chucks 110, 112). In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

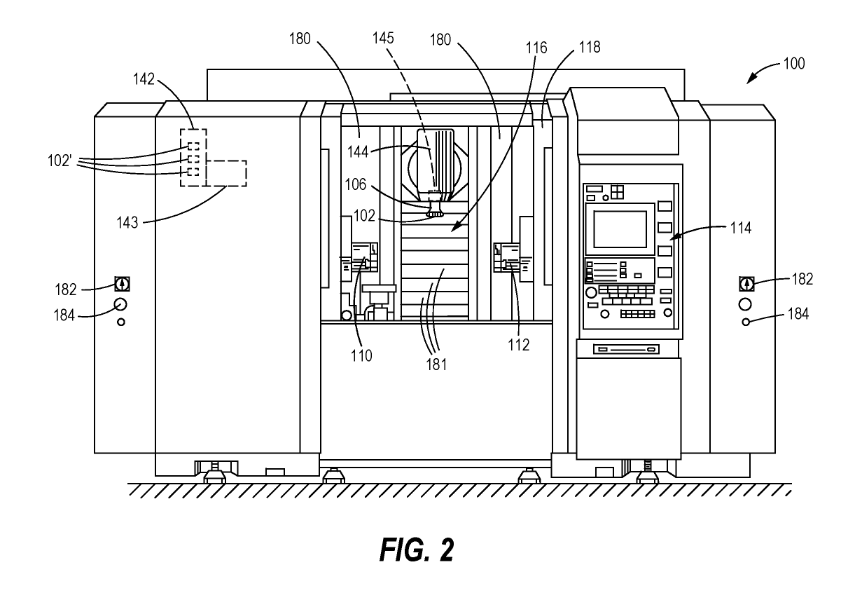

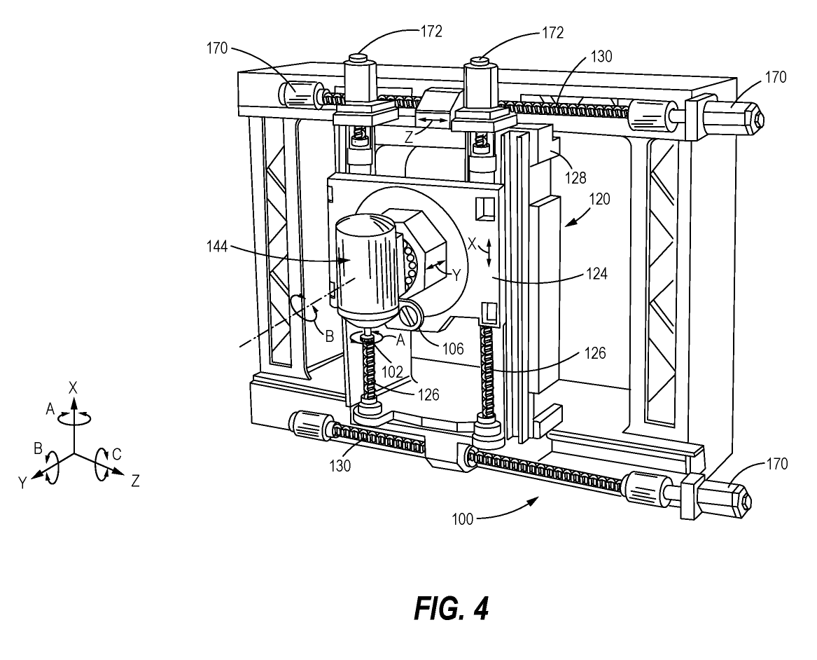

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the machine chamber 116 to prevent injury to the user or interference in the operation of the computer numerically controlled machine 100. The safety doors 118 can be opened to permit access to the machine chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface 114 allows an operator to control the second computer system. Collectively, the machine control system and the user interface system, together with the various mechanisms for control of operations in the machine, may be considered a single computer control system.

The computer control system may include machine control circuitry having a central processing unit (CPU) connected to a main memory. The CPU may include any suitable processor(s), such as those made by Intel and AMD. By way of example, the CPU may include a plurality of microprocessors including a master processor, a slave processor, and a secondary or parallel processor. Machine control circuitry, as used herein, comprises any combination of hardware, software, or firmware disposed in or outside of the machine 100 that is configured to communicate with or control the transfer of data between the machine 100 and a bus, another computer, processor, device, service, or network. The machine control circuitry, and more specifically the CPU, comprises one or more controllers or processors and such one or more controllers or processors need not be disposed proximal to one another and may be located in different devices or in different locations. The machine control circuitry, and more specifically the main memory, comprises one or more memory devices which need not be disposed proximal to one another and may be located in different devices or in different locations. The machine control circuitry is operable to execute all of the various machine tool methods and other processes disclosed herein.

In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically controlled machine 100 may have a tool magazine 142 and a tool changer 143. These cooperate with the spindle 144 to permit the spindle to operate with any one of multiple tools. Generally, a variety of tools may be provided; in some embodiments, multiple tools of the same type may be provided.

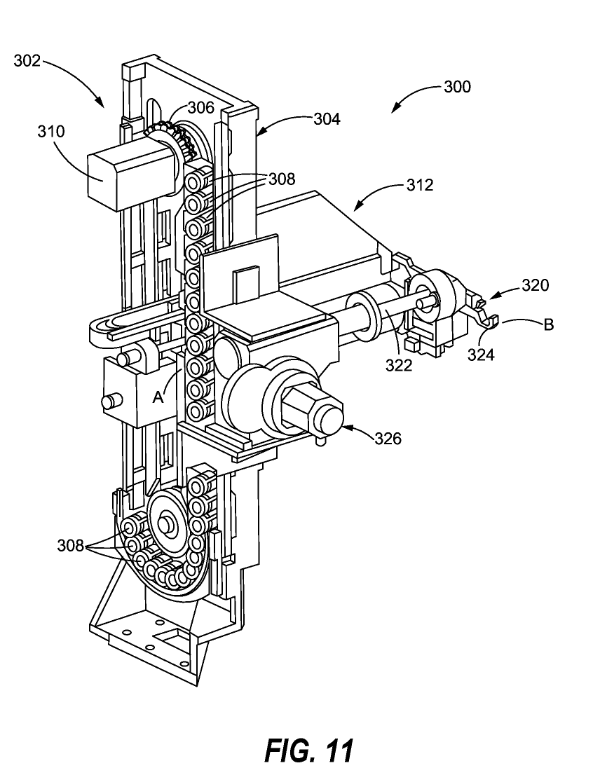

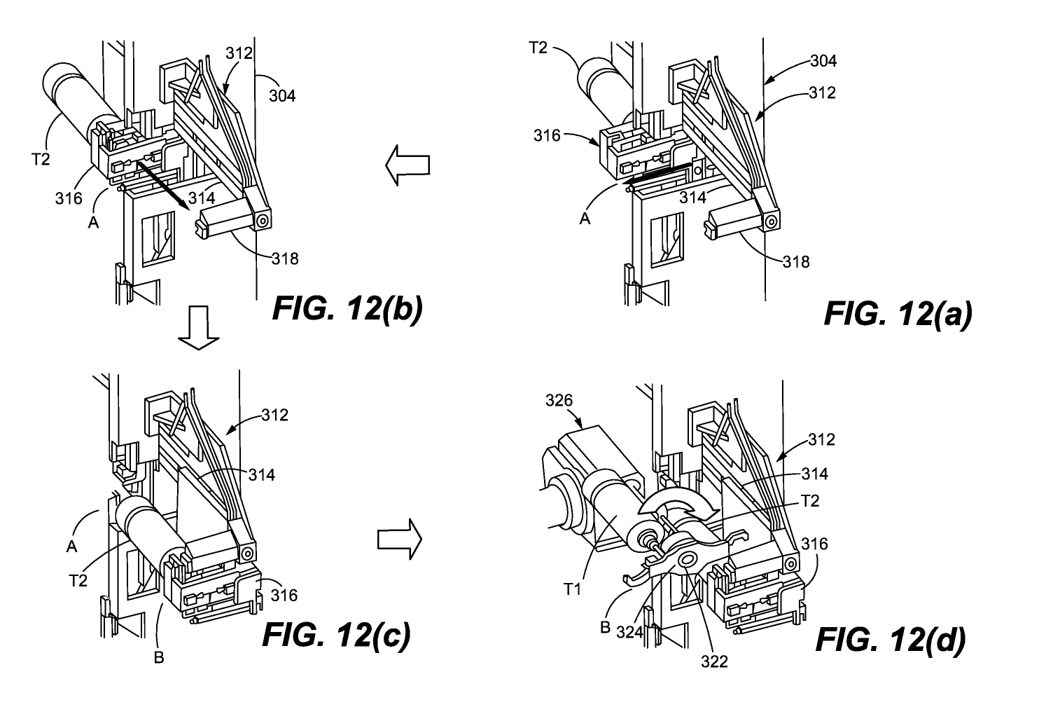

An exemplary embodiment of a tool changer 300 is illustrated in greater detail in FIGS. 11 and 12(a) to 12(d). The tool changer 300 includes a tool magazine 302 for holding a plurality of tools. The tool magazine 302 may include a magazine base 304 and an endless carrier 306 supported for rotation relative to the magazine base 304. A plurality of tool pots 308 are coupled to the endless carrier 306 at a predetermined pitch, each tool pot 308 being configured to detachably receive an associated tool. A rotary motor 310 is operably coupled to the endless carrier 306 to index the tool magazine 302 as desired.

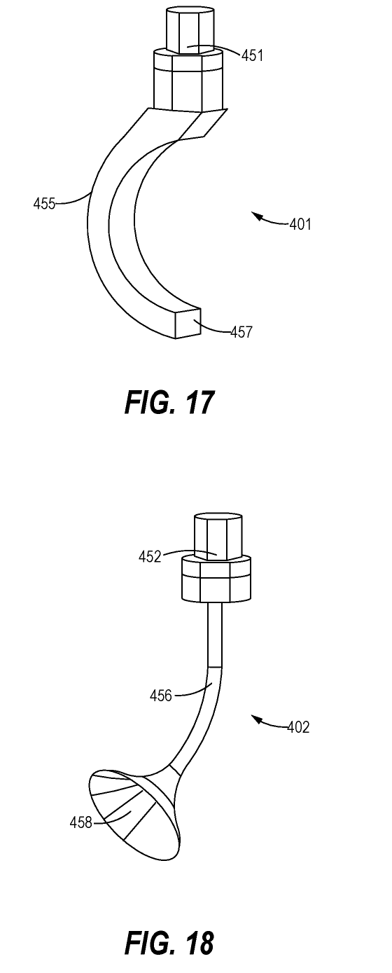

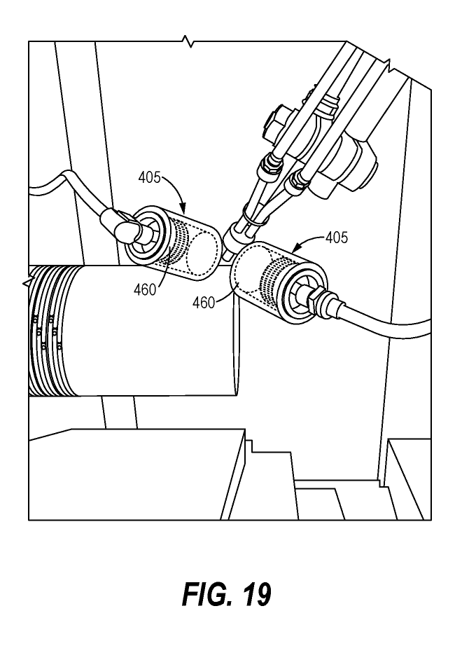

While the tool changer 300 and, by association, the tool pots 308 may hold any type of tool of the machine 100, specifically, the tool changer 300 may utilize one or more gas delivery nozzles for directing gas to specific locations within the working environment of the machine 100. For example, the machine 100 may utilize the first gas delivery nozzle 401 of FIG. 17 and/or the second gas delivery nozzle 402 of FIG. 18. As shown further in FIG. 19, the machine 100 may utilize multiple gas delivery nozzles 405 at the same time during additive manufacturing processes. Such gas delivery nozzles 401, 402, 405 of FIGS. 17-19 are any nozzle suitable for controllably supplying gas to an area or surface within the machine 100.

In some examples, the gas delivery nozzles 401, 402, 405 may be specifically configured to deliver inert gas to an environment proximate to an additive manufacturing process or build that uses reactive materials (e.g., Titanium and/or Titanium alloys, such as, but not limited to, TI 6A14V). For example, the nozzle 401 of FIG. 17 may receive inert gas from a line within the machine 100, control gas flow via a conduit 451, into a curved nozzle arm 455 and, ultimately, into the working environment via an exit orifice 457. In another example, as shown in FIG. 18, the nozzle 402 may receive inert gas from a line within the machine 100, control gas flow via a conduit 452, into a curved nozzle arm 456 and, ultimately, into the working environment via a conical exit orifice 458. The nozzles 405 of FIG. 19 include cylindrical shells 460 for further positioning inert gas location and flow. By providing inert gas in such an environment, combustion of the reactive metals may be controlled by preventing oxygen from reaching the heated metals.

The tool changer 300 also includes a tool carrier 312 for extracting a subsequent tool T2 from a tool delivery position A of the tool magazine 302 and transferring it to a tool change position B. As best shown in FIGS. 11 and 12a-d, the tool carrier 312 may include a transfer rail 314 coupled to the magazine base 304 and extending from the tool delivery position A to the tool change position B. A transfer support 316 is slidably coupled to the transfer rail 314 and configured to engage the subsequent tool T2 positioned at the tool delivery position A from the tool pot 308. A transfer motor 318 is operably coupled to the transfer support 316 to reciprocate the transfer support 316 between the tool delivery position A and the tool change position B, thereby to remove the subsequent tool T2 from the tool pot 308.

The illustrated tool changer 300 further includes a tool exchange assembly 320 for exchanging a preceding tool Ti held by the spindle 144 for the subsequent tool T2 presented at the tool change position B. the tool exchange assembly 320 may include an exchange shaft 322 supported by and rotatable relative to the magazine base 304 and an exchange arm 324 coupled to the exchange shaft 322. An exchange drive 326 is operably coupled to the exchange shaft 322 to move the exchange shaft 322 in both axial and rotational directions.

In operation, the tool changer 300 may be used to change the tool that is coupled to the spindle 144. The tool magazine 302 rotary-indexes the subsequent tool T2 to position it at the tool delivery position A, as shown in FIG. 12(a). The transfer support 316 engages the subsequent tool T2 positioned at the tool delivery position A and transfers it to the tool change position B, as shown in FIGS. 12(b) and 12(c). Next, the exchange arm 324 changes the preceding tool T1 attached to the spindle 144 to the subsequent tool T2 held by the transfer support 316, as shown in FIG. 12(d). Thereafter, the preceding tool TI may be returned to a predetermined one of the tool pots 308 of the tool magazine 302, and the subsequent tool T2 attached to the spindle 144 may be used in a subsequent process.

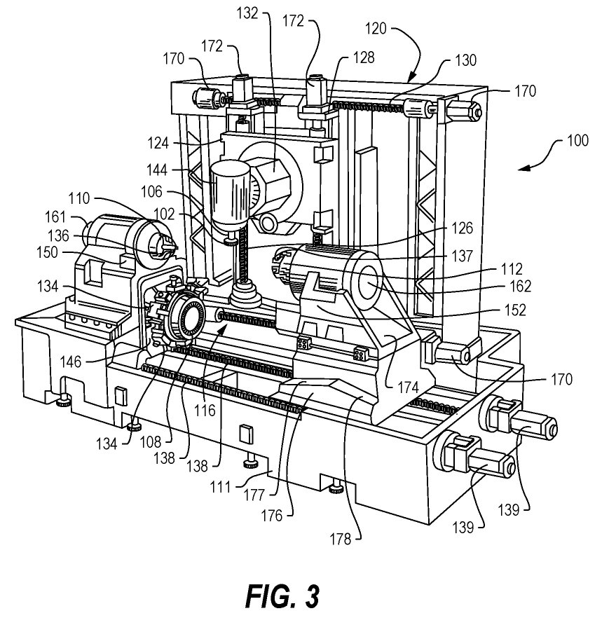

The spindle 144 is mounted on a carriage assembly 120 that allows for translational movement along the X- and Z-axis, and on a ram 132 that allows the spindle 144 to be moved in the Y-axis. The ram 132 is equipped with a motor to allow rotation of the spindle in the B-axis, as set forth in more detail below. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

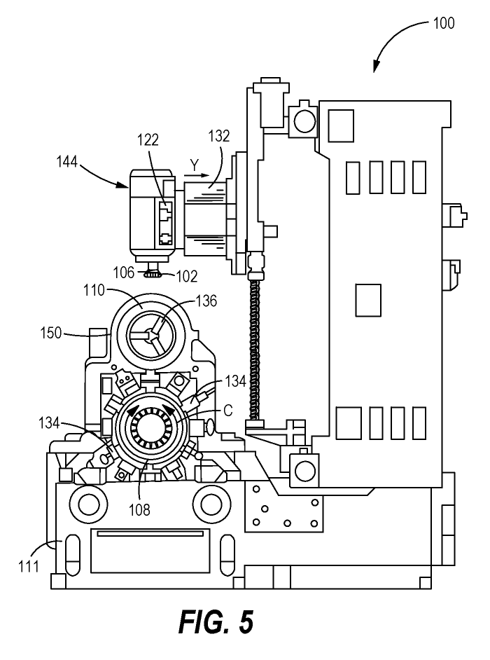

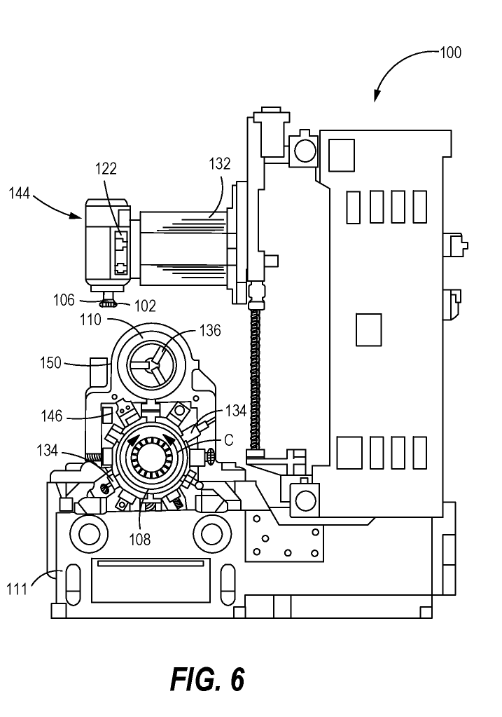

The spindle 144 holds the tool 102 by way of a spindle connection and a tool retainer 106. The spindle connection 145 (shown in FIG. 2) is connected to the spindle 144 and is contained within the spindle 144. The tool retainer 106 is connected to the spindle connection and holds the tool 102. Various types of spindle connections are known in the art and can be used with the computer numerically controlled machine 100. Typically, the spindle connection is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the second stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

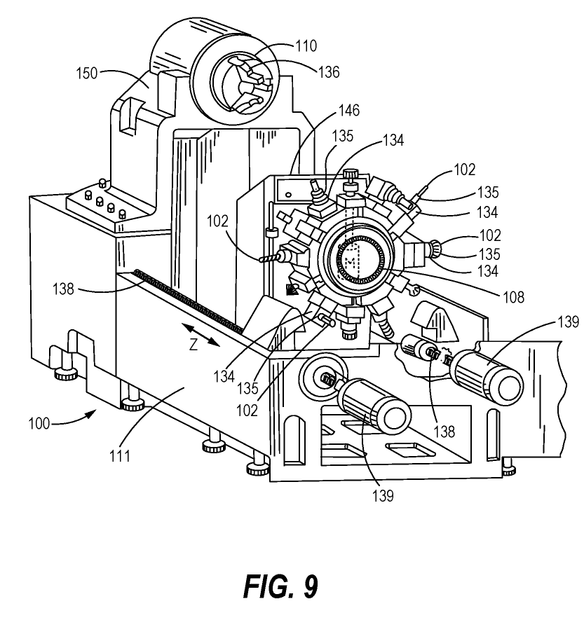

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool retainer 135 or other connection for connecting to a tool. Since the turret 108 can have a variety of turret connectors 134 and tool retainers 135, a variety of different tools can be held and operated by the turret 108. The turret 108 may be rotated in a C′ axis to present different ones of the tool retainers (and hence, in many embodiments, different tools) to a workpiece.

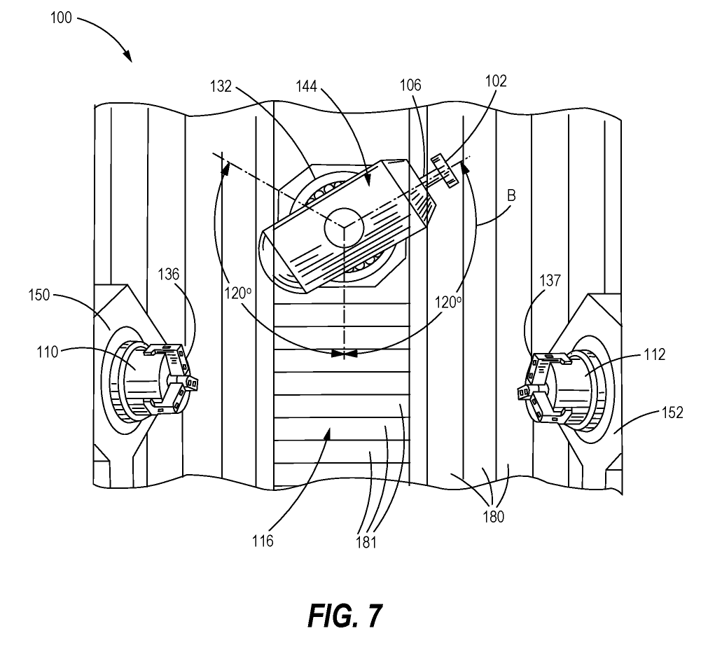

It is thus seen that a wide range of versatile operations may be performed. With reference to tool 102 held in tool retainer 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changer 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120 degrees to either side of the vertical. Movement in the Y direction and rotation in the B axis are powered by motors (not shown) that are located behind the carriage 124.

Generally, as seen in FIGS. 2 and 7, the machine is provided with a plurality of vertically disposed leaves 180 and horizontal disposed leaves 181 to define a wall of the machine chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the machine chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of tools known in the art or otherwise found to be suitable. For instance, the tool 102 may be a cutting tool such as a milling tool, a drilling tool, a grinding tool, a blade tool, a broaching tool, a turning tool, or any other type of cutting tool deemed appropriate in connection with a computer numerically controlled machine 100. Additionally or alternatively, the tool may be configured for an additive manufacturing technique, as discussed in greater detail below. In either case, the computer numerically controlled machine 100 may be provided with more than one type of tool, and via the mechanisms of the tool changer 143 and tool magazine 142, the spindle 144 may be caused to exchange one tool for another. Similarly, the turret 108 may be provided with one or more tools 102, and the operator may switch between tools 102 by causing rotation of the turret 108 to bring a new turret connector 134 into the appropriate position. In some examples, the turret may be provided with one or more of the gas delivery nozzles 401, 402, and 405.

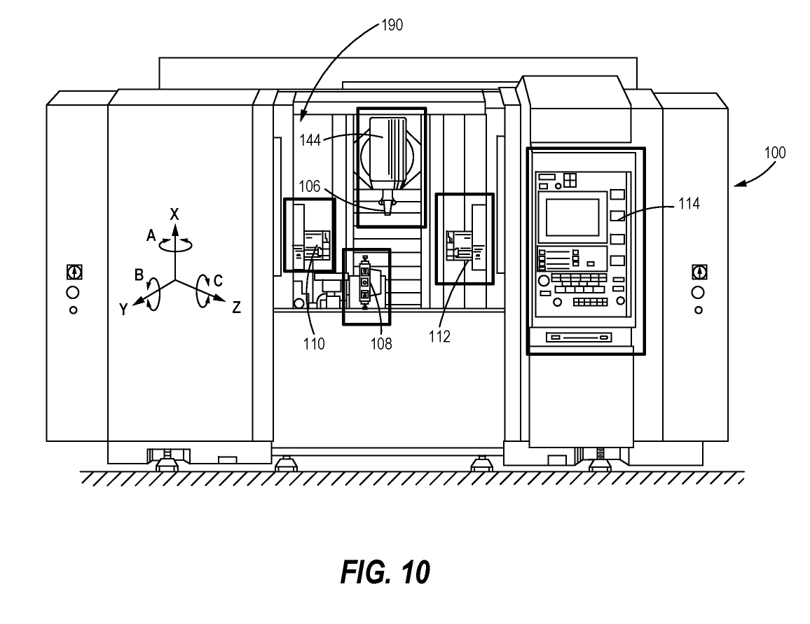

The computer numerically controlled machine 100 is illustrated in FIG. 10 with the safety doors open. As shown, the computer numerically controlled machine 100 may be provided with at least a tool retainer 106 disposed on a spindle 144, a turret 108, one or more chucks or workpiece retainers 110, 112 as well as a user interface 114 configured to interface with a computer control system of the computer numerically controlled machine 100. Each of the tool retainer 106, spindle 144, turret 108 and workpiece retainers 110, 112 may be disposed within a machining area 190 and selectively rotatable and/or movable relative to one another along one or more of a variety of axes.

As indicated in FIG. 10, for example, the X, Y, and Z axes may indicate orthogonal directions of movement, while the A, B, and C axes may indicate rotational directions about the X, Y, and Z axes, respectively. These axes are provided to help describe movement in a three-dimensional space, and therefore, other coordinate schemes may be used without departing from the scope of the appended claims. Additionally, use of these axes to describe movement is intended to encompass actual, physical axes that are perpendicular to one another, as well as virtual axes that may not be physically perpendicular but in which the tool path is manipulated by a controller to behave as if they were physically perpendicular.

With reference to the axes shown in FIG. 10, the tool retainer 106 may be rotated about a B-axis of the spindle 144 upon which it is supported, while the spindle 144 itself may be movable along an X-axis, a Y-axis and a Z-axis. The turret 108 may be movable along an XA-axis substantially parallel to the X-axis and a ZA-axis substantially parallel to the Z axis. The workpiece retainers 110, 112 may be rotatable about a C-axis, and further, independently translatable along one or more axes relative to the machining area 190. While the computer numerically controlled machine 100 is shown as a six-axis machine, it is understood that the number of axes of movement is merely exemplary, as the machine may be capable of movement in less than or greater than six axes without departing from the scope of the claims.

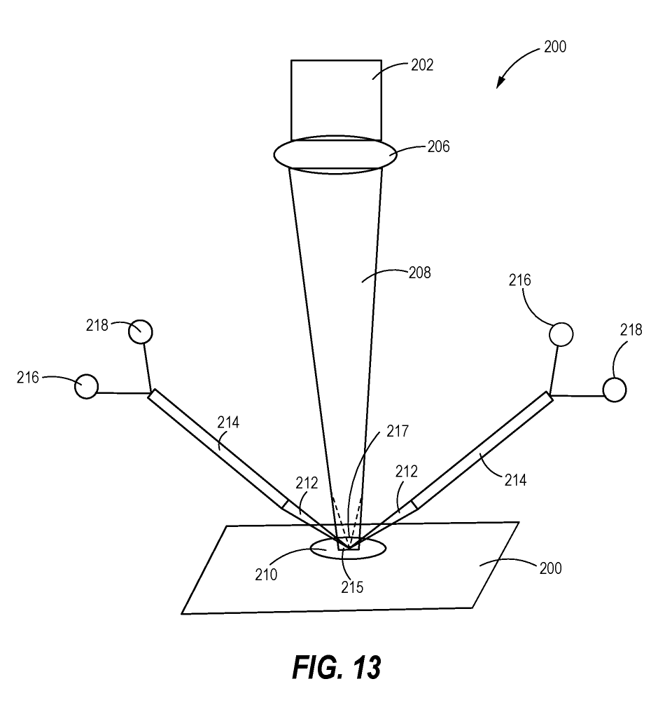

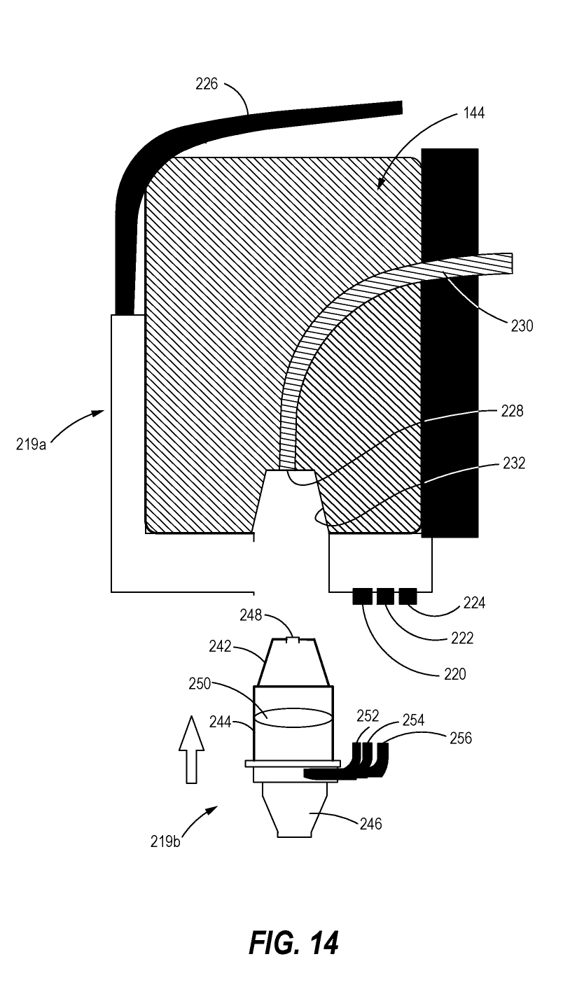

The computer numerically controlled machine 100 may include a material deposition assembly for performing additive manufacturing processes. An exemplary material deposition assembly 200 is schematically illustrated in FIG. 13 as including a fabrication energy beam 202 capable of being directed toward a substrate 204. The material deposition assembly 200 may be used in, for example, directed energy deposition. The substrate 204 may be supported by one or more of the workpiece retainers, such as chucks 110, 112. The material deposition assembly 200 may further include an optic 206 that may direct a concentrated energy beam 208 toward the substrate 204, however the optic 206 may be omitted if the concentrated energy beam 208 has sufficiently large energy density. The fabrication energy beam 202 may be a laser beam, an electron beam, an ion beam, a cluster beam, a neutral particle beam, a plasma jet, or a simple electrical discharge (arc). The concentrated energy beam 208 may have an energy density sufficient to melt a small portion of the growth surface substrate 204, thereby forming a melt-pool 210, without losing substrate material due to evaporation, splattering, erosion, shock-wave interactions, or other dynamic effects. The concentrated energy beam 208 may be continuous or intermittently pulsed.

The melt-pool 210 may include liquefied material from the substrate 204 as well as added feed material. Feed material may be provided as a feed powder that is directed onto the melt-pool 210 in a feed powder/propellant gas mixture 212 exiting one or more nozzles 214. The nozzles 214 may fluidly communicate with a feed powder reservoir 216 and a propellant gas reservoir 218. The nozzles 214 create a flow pattern of feed powder/propellant gas mixture 212 that may substantially converge into an apex 215 or region of smallest physical cross-section so that the feed powder is incorporated into the melt-pool 210. As the material deposition assembly 200 is moved relative to the substrate 204, the assembly traverses a tool path that forms a bead layer on the substrate 204. Additional bead layers may be formed adjacent to or on top of the initial bead layer to fabricate solid, three-dimensional objects.

Depending on the materials used and the object tolerances required, it is often possible to form net shape objects, or objects which do not require further machining for their intended application (polishing and the like are permitted). Should the required tolerances be more precise than are obtainable by the material deposition assembly 200, a subtractive finishing process may be used. When additional finishing machining is needed, the object generated by the material deposition assembly 200 prior to such finishing is referred to herein as “near-net shape” to indicate that little material or machining is needed to complete the fabrication process.

The material deposition assembly 200 may be incorporated into the computer numerically controlled machine 100, as best shown in FIG. 14. In this exemplary embodiment, the material deposition assembly 200 includes a processing head assembly 219 having an upper processing head 219a and a lower processing head 219b. The lower processing head 219b is detachably coupled to the upper processing head 219a to permit the upper processing head 219a to be used with different lower processing heads 219b. The ability to change the lower processing head 219b may be advantageous when different deposition characteristics are desired, such as when different shapes and/or densities of the fabrication energy beam 202 and/or feed powder/propellant gas mixture 212 are needed.

More specifically, the upper processing head 219a may include the spindle 144. A plurality of ports may be coupled to the spindle 144 and are configured to interface with the lower processing head 219b when connected. For example, the spindle 144 may carry a feed powder/propellant port 220 fluidly communicating with a powder feed supply (not shown), which may include a feed powder reservoir and a propellant reservoir. Additionally, the spindle 144 may carry a shield gas port 222 fluidly communicating with a shield gas supply (not shown), and a coolant port 224 fluidly communicating with a coolant supply (not shown). The feed powder/propellant port 220, shield gas port 222, and coolant port 224 may be connected to their respective supplies either individually or through a harnessed set of conduits, such as conduit assembly 226.

The upper processing head 219a further may include a fabrication energy port 228 operatively coupled to a fabrication energy supply (not shown). In the illustrated embodiment, the fabrication energy supply is a laser connected to the fabrication energy port 228 by laser fiber 230 extending through a housing of the spindle 144. The laser fiber 230 may travel through a body of the spindle 144, in which case the fabrication energy port 228 may be located in a socket 232 formed in a bottom of the spindle 144. Therefore, in the embodiment of FIG. 14, the fabrication energy port 228 is disposed inside the socket 232 while the feed powder/propellant port 220, shield gas port 222, and coolant port 224 are disposed adjacent the socket 232. The upper processing head 219a may further include additional optics for shaping the energy beam, such as a collimation lens, a partially reflective mirror, or a curved mirror.

The upper processing head 219a may be selectively coupled to one of a plurality of lower processing heads 219b. As shown in FIG. 14, an exemplary lower processing head 219b may generally include a base 242, an optic chamber 244, and a nozzle 246. Additionally, a nozzle adjustment assembly may be provided to translate, rotate, or otherwise adjust the position and/or orientation of the nozzle 246 relative to the energy beam. The base 242 is configured to closely fit inside the socket 232 to permit releasable engagement between the lower processing head 219b and the upper processing head 219a. In the embodiment of FIG. 14, the base 242 also includes a fabrication energy interface 248 configured to detachably couple to the fabrication energy port 228. The optic chamber 244 may be either empty or it may include a final optic device, such as a focusing optic 250 configured to provide the desired concentrated energy beam. The lower processing head 219b may further include a feed powder/propellant interface 252, a shield gas interface 254, and a coolant interface 256 configured to operatively couple with the feed powder/propellant port 220, shield gas port 222, and coolant port 224, respectively.

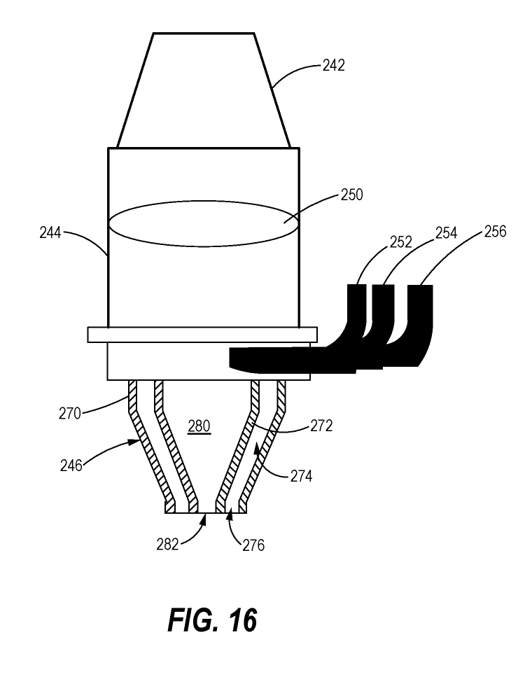

The nozzle 246 may be configured to direct feed powder/propellant toward the desired target area. In the embodiment illustrated at FIG. 16, the nozzle 246 includes an outer nozzle wall 270 spaced from an inner nozzle wall 272 to define a powder/propellant chamber 274 in the space between the outer and inner nozzle walls 270, 272. The powder/propellant chamber 274 fluidly communicates with the feed powder/propellant interface 252 at one end and terminates at an opposite end in a nozzle exit orifice 276. In the exemplary embodiment, the nozzle exit orifice 276 has an annular shape; however other the nozzle exit orifice 276 may have other shapes without departing from the scope of the present disclosure. The powder/propellant chamber 274 and nozzle exit orifice 276 may be configured to provide one or more jets of feed powder/propellant at the desired angle of convergence. The nozzle 246 of the illustrated embodiment may deliver a single, conical-shaped jet of powder/propellant gas. It will be appreciated, however, that the nozzle exit orifice 276 may be configured to provide multiple discrete jets of powder/propellant gas. Still further, the resulting jet(s) of powder/propellant gas may have shapes other than conical.

The nozzle 246 may further be configured to permit the fabrication energy beam to pass through the nozzle 246 as it travels toward the target area. As best shown in FIG. 16, the inner nozzle wall 272 defines a central chamber 280 having a fabrication energy outlet 282 aligned with the optic chamber 244 and the optional focusing optic 250. Accordingly, the nozzle 246 permits the beam of fabrication energy to pass through the nozzle 246 to exit the lower processing head 219b.

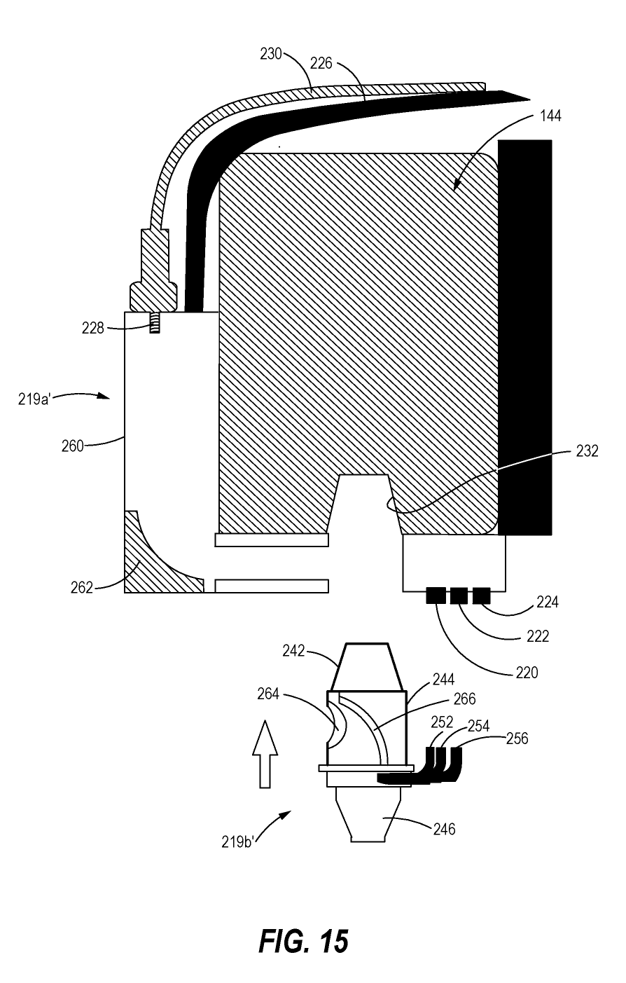

In an alternative embodiment, an upper processing head 219a′ may have the fabrication energy port 228 provided outside of the housing of the spindle 144 as best shown in FIG. 15. In this embodiment, the fabrication energy port 228 is located on an enclosure 260 provided on a side of the spindle 144, and therefore, unlike the above embodiment, this port is not provided in the socket 232. The enclosure 260 includes a first mirror 262 for directing the fabrication energy toward a point below the socket 232 of the spindle 144. An alternative lower processing head 219b′ includes an optic chamber 244 that includes a fabrication energy receptacle 264 through which the fabrication energy may pass from the enclosure 260 to an interior of the optic chamber 244. The optic chamber 244 further includes a second mirror 266 for redirecting the fabrication energy through the nozzle 246 and toward the desired target location.

While the exemplary embodiments incorporate the fabrication energy into the processing head assembly 219, it will be appreciated that the fabrication energy may be provided independent of the processing head assembly 219. That is, a separate assembly, such as the turret 108, the first chuck 110, the second chuck 112, or a dedicated robot provided with the machine 100, may be used to direct the fabrication energy toward the substrate 204. In this alternative embodiment, the processing head assembly 219 would omit the fabrication energy port, fabrication energy interface, fabrication energy outlet, optic chamber, and focusing optic.

With the processing head assembly 219 having the upper processing head 219a configured to selectively couple with any one of several lower processing heads 219b, the computer numerically controlled machine 100 may be quickly and easily reconfigured for different additive manufacturing techniques. The tool magazine 142 may hold a set of lower processing heads 219b, wherein each lower processing head in the set has unique specifications suited for a particular additive manufacturing process. For example, the lower processing heads may have different types of optics, interfaces, and nozzle angles that alter the manner in which material is deposited on the substrate. When a particular part must be formed using different additive manufacturing techniques (or may be formed more quickly and efficiently when multiple different techniques are used), the tool changer 143 may be used to quickly and easily change the particular deposition head coupled to the spindle 144. In the exemplary embodiments illustrated in FIGS. 14 and 15, a single attachment step may be used to connect the energy, feed powder/propellant gas, shield gas, and coolant supplies to the deposition head. Similarly, detachment is accomplished in a single disconnect step. Accordingly, the machine 100 may be more quickly and easily modified for different material deposition techniques.

In prior machines having additive manufacturing capabilities, the feed powder used therein typically have beads with a relatively small diameter (e.g., about 5-50 microns). Because reactive metals will absorb excessive gases, like oxygen, if such gases are present during a melting or at high temperature, combustion of reactive metals must be monitored and/or controlled. By using a small diameter bead, the feed powders are very reactive and prone to combustion when exposed to oxygen or other atmospheric gases.

As diameter of the beads of feed powder changes, the surface area to mass of the beads changes. Because the combustion reaction occurs on the surface of the powder where the metal powder is exposed to oxygen, if the powder bead's diameter is enlarged, the ratio of surface area for reaction to mass of the particle decreases. This results in lower reactivity in the metal during heating in an additive manufacturing process. Therefore, feed powders having beads with a greater diameter may have less combustibility than smaller beaded feed powders. Accordingly, the diameter of beads of a powder of reactive metal can be specifically configured to inhibit ignition upon oxidation.

For example, Titanium alloys may be produced in a powder having a diameter of over 100 microns; such powders have shown to be less combustible, explodable, or flammable than powders of the same material having a lesser diameter (e.g., 5-50 microns). More specifically, a Ti 6A14V alloy powder may be produced having a diameter of 106-180 microns, which has shown increased resistance to combustion, flammability, and explosions.

Feed powders having such larger diameter beads may be used for additive manufacturing systems, methods, and processes that utilize the aforementioned machine 100 of FIGS. 1-12, the material deposition assembly 200 of FIG. 13, and/or the processing head 219 of FIGS. 14-16. Use of feed powders, having relatively larger bead diameters, in additive manufacturing, and associated machines (e.g., machine 100), may allow for safe deposition of reactive metals without need for a vacuum or a complete purge of inert gas.

Such powders may be used in combination with local shielding via inert gas.

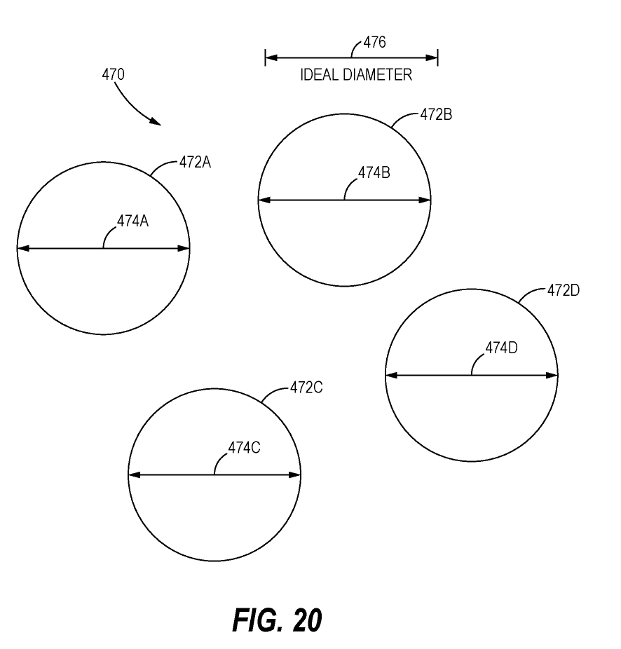

To that end, an exemplary, microscopically-magnified example of a feed powder 470, for use with the machine 100, the processing head assembly 219, and/or any other additive manufacturing machine, system, and/or apparatus, is illustrated in FIG. 20. The feed powder 470 is made from a reactive material, such as, but not limited to, Titanium alloys, such as Ti 6A14V. Accordingly, the feed powder 470, thus, is a powdered reactive material that includes, at least, a plurality of powder beads 472. Of course, while the plurality of powder beads 472, as shown, has four powder beads 472A, 472B, 472C, 472D, the plurality of powder beads 472 may include any number of powder beads 472. Each of the powder beads are, generally, substantially spherical in shape, as shown, however, certain other shapes are certainly possible. The powder beads 472 each have a corresponding bead diameter 474. As each of the powder beads 472 are substantially similar in size, each of the bead diameters 474 are substantially similar to one another.

The bead diameters 474 for each of the powder beads 472 are configured to substantially conform to an ideal bead diameter 476. To that end, each of the bead diameters 474 is substantially similar to the ideal bead diameter 476. The ideal bead diameter 476 is configured such that the feed powder 470 will not ignite upon oxidation of the powdered material; as discussed above, these are ideal conditions for performing additive manufacturing processes using reactive materials, such as those of the feed powder 470. The ideal bead diameter 476 may be different for different reactive metals and/or alloys. However, in some examples, when the bead diameter(s) 472 are greater than 100, ignition is inhibited upon oxidation of the powdered material; thus, the ideal bead diameter 476 may be a bead diameter that is greater than 100 microns. In some further examples, ignition of the feed powder 470 may be inhibited when the bead diameter(s) 472 are within a range of 106 to 180 microns and, thus, the ideal bead diameter 476 may be in the range of 106 to 180 microns. The range of 106 to 180 microns, for the ideal bead diameter 476, may be useful when Ti 6AV14V is selected as the reactive material.

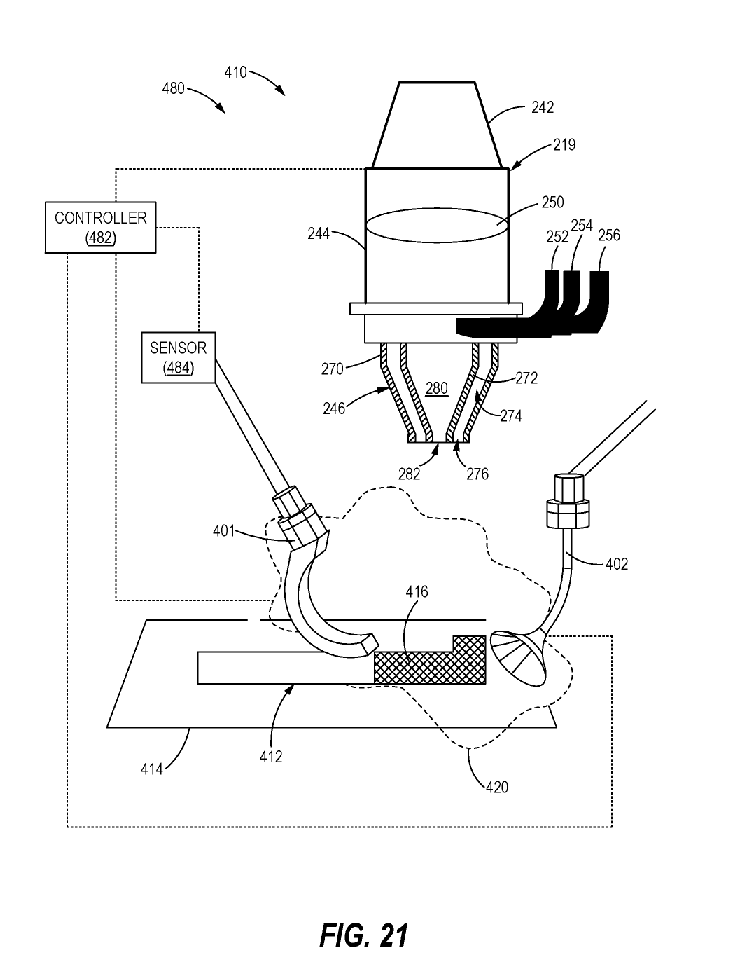

As discussed above, the machine 100 may utilize one or more nozzles 401, 402, 405 to shield build objects or portions of build objects from environmental gas, such as oxygen. FIG. 21 illustrates an example work environment 410 within the machine 100, wherein additive manufacturing occurs to create the build object 412 on a build surface 414. To that end, the machine 100, components thereof, and/or any other apparatus disclosed herein, working within the work environment 410 shown, may be utilized as a system 480 for manufacturing the build object 412. The build object 412 may be additively manufactured by utilizing an additive manufacturing tool such as, for example, the processing head 219. During build of the build object 412, the powdered reactive materials (e.g., the feed powder 470) from which the build object 412 is manufactured are heated to very high temperature for molten deposition. Oxidation of the materials deposited to build the build object 412 may occur if proper precautions are not taken by, for example, shielding the build object 412 with an inert gas (e.g., Argon gas). Such oxidation may impair the purity of the build object 412.

At such high temperatures, portions of the build object may not have cooled to a suitable temperature and may be referred to as a “hot tail” 416 of the build object 412, as exemplified by the dotted portion of the build object 412 of FIG. 21. The hot tail 416 may be specifically vulnerable to oxidation during the additive manufacturing process. Therefore, systems and methods, utilizing one or more of the first gas delivery nozzle 401, the second gas delivery nozzle 402, and the gas delivery nozzles 405 may be utilized to selectively deliver inert gas for shielding the build object 412 from harmful oxidation.

Utilizing a single gas delivery nozzle to fill an entire build chamber within the machine 100 may lead to excessive use of gas in a build, which may not be necessary when using multiple, controlled nozzles to provide gas to the build object 412, where the gas is needed. Particularly, the machine 100 may specifically control the first gas delivery nozzle 401 and the second gas delivery nozzle 402 to selectively provide an inert gas shield 420 to specific areas within the build chamber. For example, the machine 100 may be controlled to direct one or both of the first gas delivery nozzle 401 and the second gas delivery nozzle 402 to provide inert gas to an area proximate to the hot tail 416.

Such control of the gas delivery nozzles 401, 402, 405 and/or the processing head 219 (e.g., control of a toolpath) may be performed by a controller 482, which may be any controller of or operatively associated with the machine 100 and/or the system 480 (e.g., the computer control system, discussed above, elements thereof, and/or any other controller associated with the machine 100). To that end, the controller 482 may be configured to control positioning of the nozzles 401, 402 relative to one or both of the build object 412 and the processing head 219. Of course, as discussed above, subtractive manufacturing tools may be utilized within the work environment 410, as part of the system 480, and, in such examples, the controller 482 may be configured to control machining of the build object 412 by such subtractive manufacturing tool(s).

As such, the machine 100, via, for example, the controller(s) 482, may be configured to control movement of the first and second gas delivery nozzles 401, 402. Movement of the nozzle 401, 402 may be in any axis of movement and/or rotation. Additionally, the gas delivery nozzles 401, 402 may be controlled to specifically follow a path based on the build pattern of the build object 412.

Additionally or alternatively, the gas delivery nozzles 401, 402 may be controlled to follow portions of the build object 412 that are part of the hot tail 416, as deposition of the materials for the build object 412 are deposited. In such examples, the system 480 may include one or more sensor(s) 484 that are configured to determine existence and/or location of the hot tail 416 of the build object 412 and/or configured to provide data indicative of the existence and/or location of the hot tail portion 416. To that end, the sensor(s) 484 may include any visual or heat sensing device that can properly locate the hot tail 416 or provide data indicative of location of the hot tail 416 to the controller 482. Accordingly, the controller 482 may be configured to control positioning of the nozzles 401, 402 based, at least in part, on the location of the hot tail 416. Control, placement, rotation, and/or motion of the nozzles 401, 402 may be performed by any machine 100 elements and/or systems utilized for controlling a tool of the machine 100, as discussed above.

The nozzles used to accomplish such limited inert gas shielding may be application specific and configured to minimize use of gas within the machine 100. Further, features on the build objects (e.g., flanges, etc.) can cause turbulence during build, which draws oxygen into the critical, heated zone. Using secondary nozzles, such as the nozzles 401, 402, 405, may address this issue to avoid oxidation. Additionally, further gas delivery may be provided from nozzles located at or associated with other elements of the machine 100. For example, gas delivery nozzles associated with the turret 108 may be employed for efficient, directed, inert gas delivery for shielding.

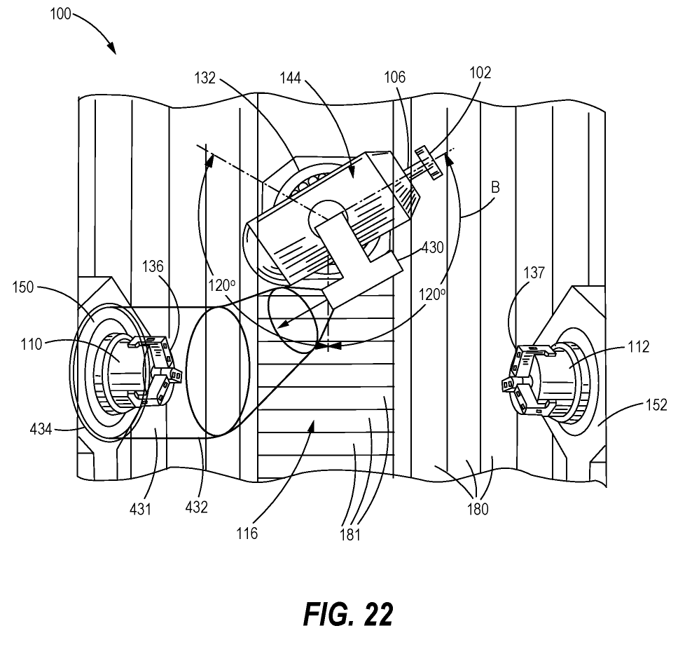

Turning now to FIG. 22, an interior view of the machine 100 is shown, including an additive manufacturing tool 430 and flexible build support enclosure 431, which, for example, is or includes a bag 432, for housing a build, at least in part, within an inert gaseous environment during additive manufacturing by the additive manufacturing tool 432. The bag 432 may be filled with an inert gas to prevent oxidation on a build object. By using the bag 432, the amount of inert gas used may be reduced and concentrated on the build area and/or a hot tail that especially needs shielding from oxygen or other environmental gases. Thus, the flexible build support enclosure 431 may shield the build object from environmental gases within the machine 100, during construction.

As shown, the bag 432 may be affixed circumferentially around a rotatable member, such as the chuck 110, which allows the chuck 110 to rotate without limiting movement of the additive manufacturing tool 432 based on the elasticity of the bag. This is performed by mounting the bag 432 to the chuck 110 using a bearing 434 concentric with the chuck 110, so it does not rotate when the chuck 110 rotates. While the bag 432 is shown rotatably mounted to the chuck 110, it may be rotatably mounted to any other element within the machine 100 that would require an inert gas enclosure.

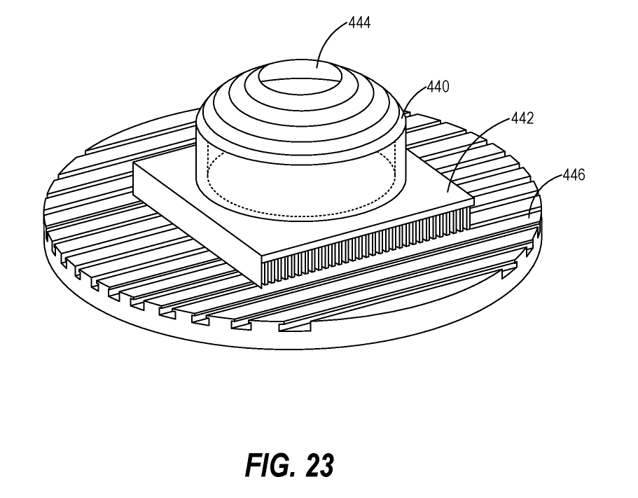

Another example bag 440 for housing a build on a substrate 442, within an inert gaseous environment, during additive manufacturing by an additive manufacturing tool is shown in FIG. 23. The bag 440 may have an opening 444, in which an additive manufacturing tool may enter to build a build object atop the substrate 440. The bag 440 may be configured to not rotate with movement of, for example, a surface 446, during an object build.

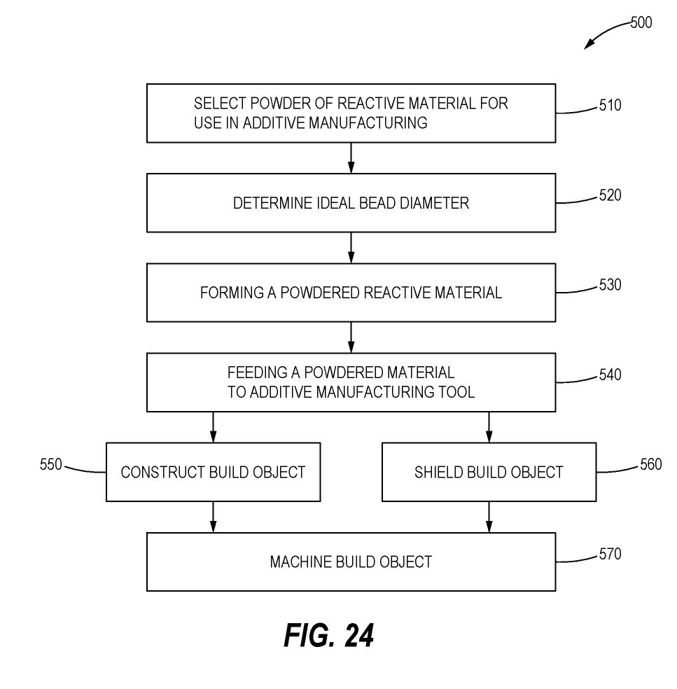

Turning now to FIG. 24, an exemplary method 500 for additive manufacturing a build object is illustrated in a block diagram. The method 500 may utilize any of the aforementioned systems, method, and apparatus described above, including any and all elements associated with or part of the machine 100. The method 500 may be specifically configured to prevent oxidation of a build object during the additive manufacturing process.

The method 500, which may be, but is not limited to being, performed utilizing one or more elements of the machine 100 and/or the system 480, discussed above, begins at block 510, wherein a reactive material is selected to be used in constructing the build object 412. In some examples, selecting the reactive material to be used in constructing the build object includes selecting a Titanium alloy as the reactive material, as discussed above. Further still, in some examples, selecting the reactive material to be used in constructing the build object includes selecting Ti 6AV14V as the reactive material.

With the reactive material selected, the ideal bead diameter 476 may then be determined, wherein the ideal bead diameter 476 is one at which ignition of the reactive material, in a powdered form, is inhibited, upon oxidation of the reactive material, as depicted in block 520. As discussed above, such a determination of the ideal bead diameter 476 may include determining a bead diameter that is greater than 100 microns as the idea bead diameter 476. Further still, in some examples, such as those discussed above, determining the ideal bead diameter includes determining a bead diameter that is in the range of 106-180 microns as the ideal bead diameter.

With the ideal bead diameter 476 selected, the method 100 further includes forming a powdered reactive material (e.g., the feed powder 470) from the reactive material, wherein the powdered reactive material includes the plurality of powder beads 472, as depicted in block 530. Each of the powder beads 472 has a bead diameter 474, which is substantially similar to the ideal bead diameter 476. With the powdered material configured, the method 100 further proceeds to feeding the powdered material to an additive manufacturing tool (e.g., the processing head 219), as depicted in block 540, and constructing the build object by depositing the powdered material, in a molten state, over a series of iterations, as depicted in block 550.

In some examples, the method 500 may further include selectively shielding the build objects during construction of the build object, by using an inert gas, as depicted in block 560. Such shielding may be achieved via use of one or more nozzles 401, 402, 405 and/or via use of the flexible build support enclosure 431. In some examples, optionally, the method 100 may further include machining the build object, by using one or more subtractive manufacturing tools of the machine 100.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

1. A system for manufacturing a build object, the system comprising:
an additive manufacturing tool, the additive manufacturing tool configured to utilize a powdered reactive material to construct the build object, the powdered reactive material including a plurality of powder beads, each powder bead having a bead diameter that is substantially similar to an ideal bead diameter;
one or more nozzles configured to selectively shield the build object during additive manufacturing of the build object, by the additive manufacturing tool, using an inert gas; and
at least one controller configured to control a toolpath of the additive manufacturing tool and configured to control positioning of the one or more nozzles relative to one or both of the build object and the additive manufacturing tool.

2. The system of claim 1, further comprising at least one subtractive manufacturing tool, and
wherein the at least one controller is further configured to control machining of the build object performed by the at least one subtractive manufacturing tool.

3. The system of claim 1, wherein the controller is configured to control positioning of the one or more nozzles based on the location of a hot tail portion of the build object.

4. The system of claim 3, further comprising a sensor configured to determine existence and location of the hot tail portion of the build object, and
wherein the controller is configured to control positioning of the one or more nozzles based, at least in part, on the existence and location of the hot tail portion, such that the hot tail portion is shielded by the inert gas during additive manufacturing.

5. The system of claim 1, wherein the controller is configured to control positioning of the one or more nozzles based, at least in part, on the toolpath of the additive manufacturing tool such that the build object is shielded by the inert gas during additive manufacturing.

6. The system of claim 1, further comprising a powder feed configured to provide the powdered reactive material to the additive manufacturing tool, and
wherein the ideal bead diameter is greater than 100 microns.

7. The system of claim 6, wherein the powdered reactive material is a Ti 6A14V and the ideal bead diameter is within a range of 106 microns to 180 microns.

8. A manufacturing machine configured to build and machine a build object, the machine comprising:
an additive manufacturing tool, the additive manufacturing tool configured to utilize a powdered reactive material to construct the build object, the powdered reactive material including a plurality of powder beads, each powder bead having a bead diameter, each bead diameter being substantially similar an ideal bead diameter, and
a flexible build support enclosure configured to, at least partially, house the build object during construction by the additive manufacturing tool and enclose, at least partially, inert gas for shielding the build object from environmental gases.

9. The manufacturing machine of claim 8, wherein the flexible build support enclosure includes, at least, a bag that partially houses the build object during construction and encloses, at least, partially, the inert gas.

10. The manufacturing machine of claim 9, further comprising a rotatable member, and
wherein the bag is configured to not rotate with the rotatable member.

11. The manufacturing machine of claim 10, wherein the rotatable member is a rotatable chuck configured to rotate independent from the bag, and
wherein the bag is affixed circumferentially around the chuck and configured to not rotate with the chuck.

12. The system of claim 1, further comprising a powder feed configured to provide the powdered reactive material to the additive manufacturing tool,
wherein the ideal bead diameter is greater than 100 microns.

13. The system of claim 6, wherein the powdered reactive material is Ti 6A14V and the ideal bead diameter is within a range of 106 microns to 180 microns.

14. A method for manufacturing a build object, the method comprising:
selecting a reactive material to be used in constructing the build object;
determining an ideal bead diameter for the reactive material, the ideal bead diameter being a bead diameter at which ignition of the reactive material is inhibited, upon oxidation of the reactive material;
forming a powdered reactive material from the reactive material, the powdered reactive material including a plurality of powder beads, each powder bead having a bead diameter, each bead diameter being substantially similar to the ideal bead diameter;
feeding the powdered material to an additive manufacturing tool; and
constructing the build object by depositing the powdered material, in a molten state, over a series of iterations.

15. The method of claim 14, wherein determining the ideal bead diameter for the reactive material includes determining a bead diameter that is greater than 100 microns as the ideal bead diameter.

16. The method of claim 14, wherein determining the ideal bead diameter for the reactive material includes determining a bead diameter that is in the range of 106-180 microns as the ideal bead diameter.

17. The method of claim 16, wherein selecting the reactive material to be used in constructing the build object includes selecting a Titanium alloy as the reactive material.

18. The method of claim 17, wherein selecting the reactive material to be used in constructing the build object includes selecting Ti 6AV14V as the reactive material.

19. The method of claim 14, further comprising selectively shielding the build object during construction of the build object by using an inert gas.

20. The method of claim 14, further comprising machining the build object, using one or more subtractive manufacturing tools.
